(19) United States
(12) Patent Application Publication
(10) Pub. No.: US 2026/0142541 A1
(43) Pub. Date: May 21, 2026

(54) MAGNETIC MEMORY DRIVE

(71) Applicant: John Vranish, Crofton, MD (US)

(72) Inventor: John Vranish, Crofton, MD (US)

(21) Appl. No.: 19/393,122

(22) Filed: Nov. 18, 2025

Related U.S. Application Data
(60) Provisional application No. 63/721,726, filed on Nov. 18, 2024.

(51) Int. Cl. H02K 23/14; B60L 3/10; B60L 7/18; H02K 23/04

(52) U.S. Cl. CPC H02K 23/14; B60L 3/108; B60L 7/18; H02K 23/04

(57) ABSTRACT

A magnetic memory drive system and apparatus, capable of functioning as a generator, including within applications of regenerative braking. The system may perform as an electric generator by forcing rotor rotation against magnetized poles and using the pole coils to induce AC current from the oscillating magnetic flux between the magnetized poles and the moving rotor. Further, energy stored in super capacitors of the system can provide an immediate burst of power to either drive or brake wheels of a vehicle beyond normal system capabilities for short periods of time.

Additionally, can perform computer-controlled brake pumping whereby magnetic braking is switched on and off to prevent sliding on water or ice.

### CONTINUITY

This application is a non-provisional application of provisional patent application number 63/721,726, filed on Nov. 18, 2024, and priority is claimed thereto.

### FIELD OF THE PRESENT INVENTION

The present invention relates to the field of electric motors, and more specifically relates to a new oscillating electric engine which employs rapidly oscillating magnetic fields to facilitate rotation of a rotor in a controlled manner.

### BACKGROUND OF THE PRESENT INVENTION

Electric vehicles continue to grow in use around the world. However, present electric vehicles maintain an assortment of drawbacks. Battery-powered electric vehicles generally have ranges that are too small. Furthermore, the time it takes to charge the batteries of electric vehicles remains long, as on-board batteries used in electric vehicles are quite large and heavy.

If there were a new form of electric motor that required less power without sacrificing performance, electric vehicle adoption rates would increase.

Electric motors presently available in the current art create Back EMF (Electro-Motive Force) during Rotor movement which operates on the low-impedance drive coil circuit. This reduces the drive's electromagnetic force and unfortunately must be compensated by more drive current and more battery drain.

If there were an electric motor equipped with a rotor configured to move the current off, drive coils of the electric motor could be reconnected to a high impedance resolver measurement circuit in the motor system microcontroller, where further charge is saved by reducing back electromotive force (Back EMF) current and eliminating the need for a dedicated Resolver, while high resolution measurements of Rotor movement and position are made because the Drive Coils are optimally positioned to do so and because the large number of coil windings used to drive a motor are equally effective in performing as a resolver. In such a system, battery charge is saved because the parasitic effects of back EMF are greatly reduced, because the drive coils acting as a resolver can provide more precise and accurate control, which improves efficiency and because a separate dedicated Resolver is not needed.

Thus, there is a need for a new electric motor design configured to capitalize on the benefits provided by the reduction and/or removal of back EMF such that battery power is saved and optimized, and motor efficiency is maximized. Such a system preferably employs a high magnetization/demagnetization speed provided by hard ferrite magnetic material which enables “zero current remanence” to yield more optimal results. Further, such a system preferably employs a high output impedance DC voltage source to slowly charge a drive capacitor to ensure a controlled short burst of large current, enabling the high magnetization/demagnetization speed of ferrite poles within the motor.

Implementation of such a system presents new challenges. The high magnetization/demagnetization speed of the hard ferrite poles requires a controlled, short burst of large current. Currently, such a system requires a DC Voltage Source capable of such performance which is typically low output impedance. These are unfortunately heavy and expensive. Therefore, such a system preferably employs a high output impedance DC voltage source to slowly charge a drive capacitor as part of an RC circuit in which “R” is a variable resistor during current off time while the rotor is moving. At the appropriate time, the system is configured to magnetize or demagnetize selected poles with a controlled burst of current using the RC time constant to control the current through select pole coils with respect to time. Variable resistance can be accomplished using a switched capacitor variable resistor system or an array of fixed value resistors. A switched capacitor resistor is a continuously variable resistor depending on switch rates in which the microcontroller can provide the switch rates. A DC voltage source can slowly charge the capacitor while the motor is moving current off, and can provide a large, short burst of current at the proper time. This enables a smaller, lighter, and less costly DC voltage source to power the system with performance normally provided by a larger, heavier more expensive low output impedance power supply as shown in the prior art. Positive and negative DC voltage sources can be used with such a system as some poles are magnetized as north poles while, simultaneously, others are magnetized as south poles. Switching speeds of FETs are even faster than ferrite magnetization/demagnetization speed, therefore control of the burst of current of the system of the present invention is precise and accurate. Microcontrollers have the speed and programming versatility to support the magnetic memory drive system of the present invention.

### SUMMARY OF THE INVENTION

The present invention is an electric motor system employing magnetic memory drive motors equipped with microcontroller control, a high-speed switching system, and the hard ferrite speed of magnetization/demagnetization and current off rotor movement, assisted by accurate and precise rotor speed and position measurements can provide many functions of special motor designs using the system of the present invention including, but not limited to:
a) stepper motor performance can be accomplished by coming to a stop after each step. The system can be run open loop simply by counting steps with no feedback required.
b) Servo motor performance can be enhanced by demagnetizing the destination pole and simultaneously magnetizing the next pole while the rotor is in motion, thereby providing continuous motion.

The location and speed of the rotor is measured by pole coils in a resolver listening mode. Servo motor speed is preferably controlled by using a single basic configuration, via microcontroller control. To increase speed, the drive capacitors are charged with more current and the hard ferrite is magnetized to a higher hysteresis loop with a higher remanence level. This causes the rotor to move faster between poles, and to shorten the time between pole set magnetization/demagnetization so the faster rotor poles arrival/departure is properly coordinated.

To reduce speed of the rotor, the hard ferrite is magnetized to a lower hysteresis loop with a lower remanence. This causes the rotor to move slower between poles, and therefore lengthens the time between pole set magnetization/demagnetization so the slower rotor poles arrival/departure is properly coordinated. To hold the rotor in position at a “stop” between stator poles, the system is configured to magnetize several stator poles such that the center of magnetic attraction exists at some point between specific stator and rotor poles.
c) Advanced stepper motor performance can be achieved by skipping steps while rapidly moving towards a destination, adding steps while approaching the destination and magnetically hold position current off once in position.

As such, the preferred embodiments of the present invention employ super hard permanent magnets in the rotor (such as neodymium boron iron) that cannot be demagnetized by the hard ferrite used in the stator, motor, generator, and/or magnetic brakes. Versions of this configuration can also use magnetic memory drives.

Magnetic memory drive motors of the present invention can be configured with brushes and with hard ferrite poles with windings in both stator and rotor whereby both stator and rotor can be instantly and synchronously magnetized and demagnetized to provide extraordinary performance with minimal charge consumption.

The following brief and detailed descriptions of the drawings are provided to explain possible embodiments of the present invention but are not provided to limit the scope of the present invention as expressed herein this summary section.

### BRIEF DESCRIPTION OF DRAWINGS OF THE PRESENT INVENTION

The accompanying drawings, which are incorporated herein and form a part of the specification, illustrate the present invention and, together with the description, further serve to explain the principles of the invention and to enable a person skilled in the pertinent art to make and use the invention.

The present invention will be better understood with reference to the appended drawing sheets, wherein:

FIG. 1 is a diagram detailing a preferred embodiment of the system of the present invention.

FIG. 2 depicts the poles of the present invention, capable of rapid magnetization/demagnetization.

FIG. 3 shows the electric motor configuration of preferred embodiments of the present invention.

FIG. 4 exhibits a schematic of a generator embodiment of the present invention.

### DETAILED DESCRIPTION OF THE PRESENT INVENTION

The present specification discloses one or more embodiments that incorporate the features of the invention. The disclosed embodiment(s) merely exemplify the invention. The scope of the invention is not limited to the disclosed embodiment(s).

References in the specification to “one embodiment,” “an embodiment,” “an example embodiment,” etc., indicate that the embodiment described may include a particular feature, structure, or characteristic, but every embodiment may not necessarily include the particular feature, structure or characteristic. Moreover, such phrases are not necessarily referring to the same embodiment, Further, when a particular feature, structure, or characteristic is described in connection with an embodiment, it is submitted that it is within the knowledge of one skilled in the art to affect such feature, structure, or characteristic in connection with other embodiments whether or not explicitly described.

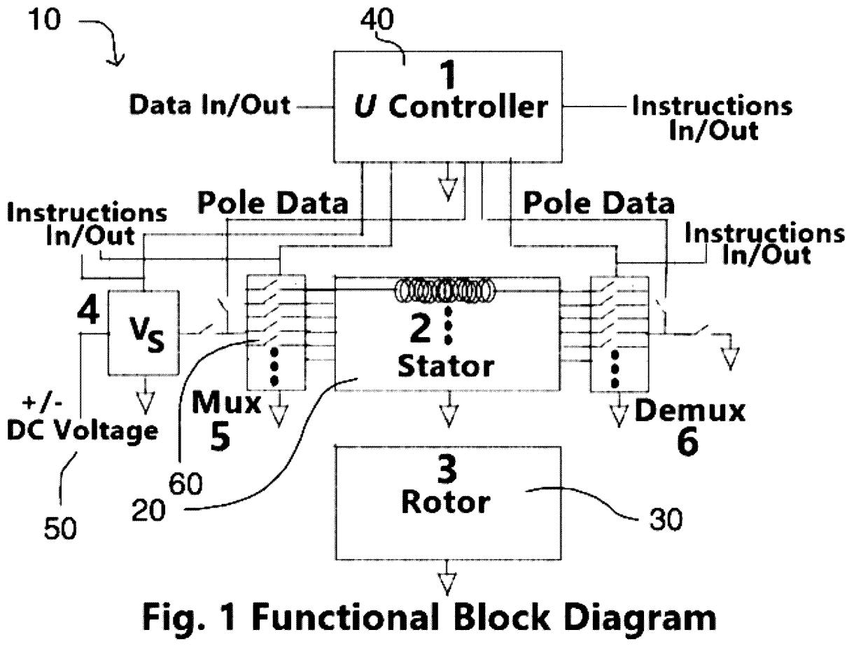

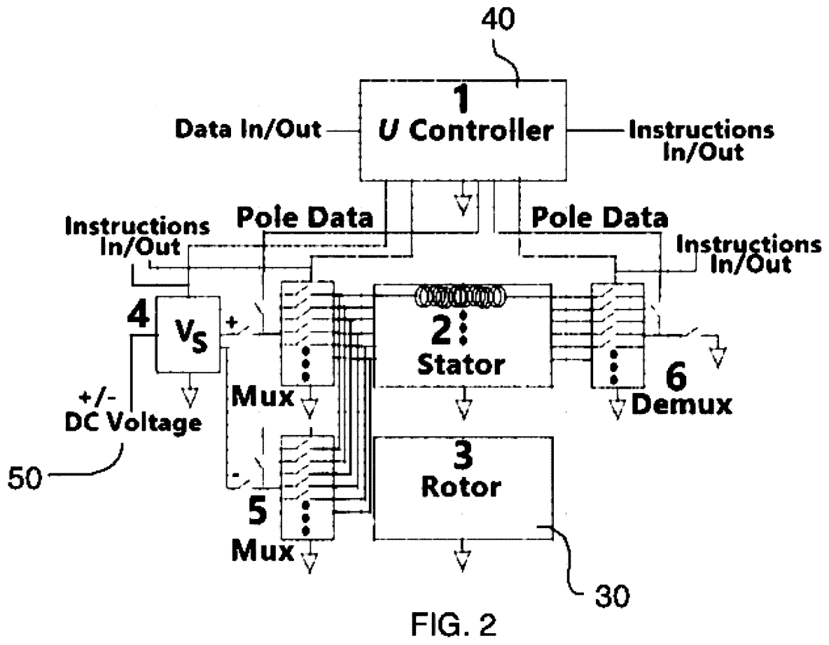

The present invention is a novel system and method for driving an electric engine, referenced as a magnetic memory drive (10), employing a stator (20), a rotor (30), a microcontroller (40), a power supply (50) and a switching system (60) as depicted in FIG. 1. The present invention exhibits the ability to simultaneously magnetize one set of poles while demagnetizing another as shown in FIG. 2. The speed and precision of magnetic memory drives of the present invention is much faster than changes in rotor inertia of traditional electric drives that magnetization of one set of poles followed by immediate demagnetization of another such that pole switching using FIG. 1 can provide continuous rotor movement with smoothness essentially the same as that provided by FIG. 2. As the rotor approaches the end of its movement between poles, the next set of poles can be magnetized instantly followed by the immediate set of poles being demagnetized. This can be called “Bing-Bang” pole switching, as it happens rapidly.

Electric motors use less charge with no reduction in performance when outfitted with the system and apparatus of the present invention. The high magnetization/demagnetization speed of ferrite magnetic material and its'zero current remanence (memory) properties can be leveraged to save electrical charge in electric motor operations. Both hard and soft ferromagnetic materials presently available can be magnetized and demagnetized at speeds approaching 5 km per sec [ref. 1]. This implies 2.54 km/sec can be used in practice. It becomes advantageous to construct electric motor stator poles of hard ferromagnetic material with wide hysteresis loops and large zero current remanence (memory), as well as rotor poles of soft ferromagnetic material with high permeability, narrow hysteresis loops and small zero current remanence.

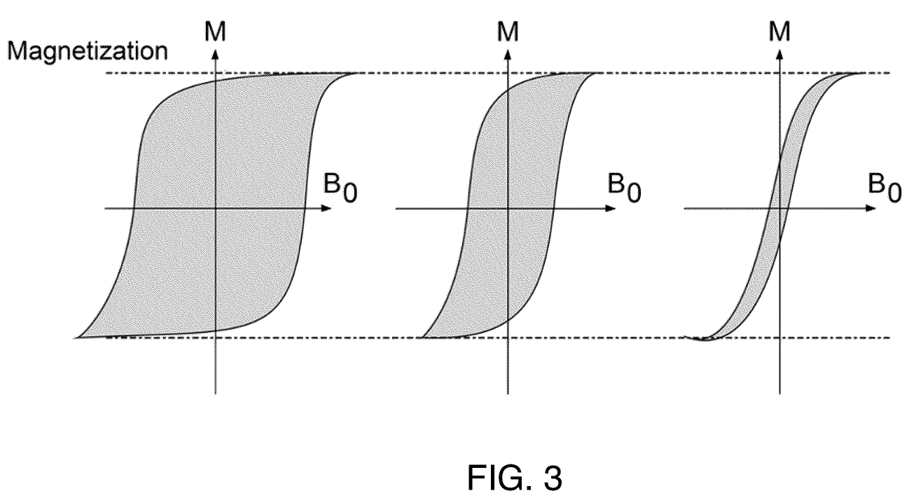

This motor configuration, as depicted in FIGS. 1, 2, and 3 is controlled by a microcontroller (40), a DC voltage source system (50) and a high-speed switching system (60) whereby motor configuration changes can be quickly performed. It becomes advantageous to selectively magnetize hard ferromagnetic poles in the stator (20) with a short burst of large current, then immediately shut off the current leaving sufficiently high magnetic memory to drive the rotor with current off permanent magnet flux before the rotor has time to move significantly. When the rotor reaches the magnetized stator pole(s), these pole(s) are demagnetized, new stator pole(s) are magnetized, the rotor demagnetizes itself and rotor motion continues.

The magnetic memory drive is very different from present practice in which the stator with soft ferromagnetic poles selectively magnetizes a pole set and keeps current on until soft ferromagnetic rotor pole(s) move into alignment with the stators'electromagnetically energized pole(s) and a motor step is complete. A new set of stator pole(s) is electromagnetically magnetized and rotor motion continues. Current is kept on throughout operation of the motor(s), unlike in the present invention. Soft ferromagnetic material is used in both stator and rotor so magnetic remanence from the previous pole does not drag on the rotor moving to the next pole(s). The two system types will now be compared. Hard ferrite materials presently used in magnetic memories have been measured to magnetize/demagnetize at speeds approaching five Km/second as a limit. The system of the present invention uses 2.54 Km/second as a practical magnetization/demagnetization working speed and 25.4 mm (1 in) as the pole height of a representative electric motor. This means a pole of the present invention will magnetize/demagnetize in (25.4/((2.54E6) second=10 E−6 second. For a motor rotating at 60 rpm (1 rps) with 20 poles, it takes 50(E−3) seconds for the rotor to move between poles. This is 5,000 times longer than pole magnetization/demagnetization time. However, hard ferrite material takes approximately five times as much current to magnetize/demagnetize as soft ferrite material, therefore additional current is required. When comparing the effects of a large current for a short time vs a smaller current for a longer time: 5(I)(10 E−6 sec)=5(I)(E−6) coulombs vs (I)(5E−2 ) coulombs, which computes to the hard ferrite method using 1/10,000 as much charge as the present art soft ferrite method (I=current in amps).

The sequential operating steps of the magnetic memory drive of the present invention preferably include:
1) First, the microcontroller selecting the Pole(s) to be magnetized and switching in the appropriate circuit(s). The DC power supply is connected to the mux, through the mux to the appropriate pole(s), through the pole windings to the Demux, through the Demux to ground.
2) Next, the poles are magnetized and demagnetized.
3) Then, the coils are disconnected from the power supply and ground and reconnected to the input measurement terminal of the microcontroller.
4) Then the rotor starts to move.
5) The coil windings act as a resolver and motor performance is monitored and analyzed.
6) At the proper time, one set of poles is demagnetized while another is magnetized, and the next step begins.

Motor power is deactivated during Steps 3, 4, and 5 and battery charge is saved.

To better understand the reasons for the sequential operating steps, the speed of magnetization/demagnetization is considered with respect to rotor speed. Assuming an electric motor turning at 60 rpm (1 rps). We assume a motor with 200 steps per revolution (1/200=5 (E−3) sec) per step). This is required for a high precision stepper that is turning rapidly for such precision.

Even so, the speed of magnetization/demagnetization is so rapid, that the magnetic memory concept of the present invention is able to deliver optimized results. Hard ferrite material presently available for use in magnetic memory drives can magnetize/demagnetize at speeds approaching 5 KM/second. A working value of 2.54 km/sec will be used and a stator pole height of 25.4 mm (1 in) will be chosen for the representative motor. A pole of the present invention can magnetize/demagnetize in 25.4 mm/(2.54 KM) sec=10 (E−6) sec.

The poles are magnetizing/demagnetizing 500 times faster than the motor is turning. This makes it attractive to magnetize the pole(s) and turn the motor current off.

Hard ferrite material used in magnetic memory drives typically takes about 5 times as much magnetization current as the soft ferrite electromagnets widely used in electric motors today. It is posited that the system has 5 (I) amps current×10 (E−6) sec=50 (E−6) coulombs (magnetic memory drives) vs 1 (I) amps current×5 (E−3) sec=5 (E−3) coulombs present practice current on drives. This computes to a charge savings of 100 times or 2 orders of magnitude or 10,000 percent. These savings will make a significant improvement in vehicle range and recharge times. To this point we have considered stepper motor performance where the rotor stops at the end of each step. Smooth, continuous rotor motion is also possible by switching poles while the rotor is nearing the end of its movement between Poles before it starts to lose momentum. Smooth, continuous Rotor motion can be accomplished either by using the system shown in FIG. 2 or by using the system shown in FIG. 1 with what can be referenced as “Bing-Bang” (because the two events happen so close together) techniques.

Therefore, as the rotor approaches the end of a step, before its momentum begins to slow, the next pole set is magnetized, followed instantly by demagnetizing the immediate ole set (Bang-Bang oscillation). To achieve the precise short bursts of large current required, a storage capacitor can be used between the DC voltage source and the coils of the present invention. This capacitor can be charged while the Rotor is moving between Poles current off and can be discharged at the appropriate time to magnetize and or demagnetize the Poles. An RC circuit with a switched capacitor time variable resistor can provide the discharge precise control and responsiveness needed, even when using light weight small high-output-impedance voltage Sources.

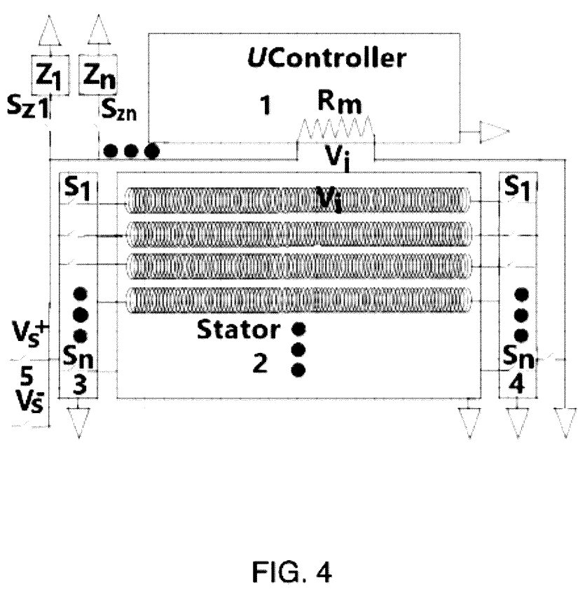

Alternate embodiments of the present invention include variations on implementation of the system and method. For example, the present invention can perform as an electric generator by forcing rotor rotation against magnetized poles and using the pole coils to induce AC current from the oscillating magnetic flux between the magnetized poles and the moving rotor as shown in FIG. 4. The coils can be terminated in ground on one end and a low impedance load on the other end which results in large, induced current. The voltage across the coils (labeled Vi) can be measured by a high impedance circuit in the microcontroller (labeled 1) as in the resolver application of magnetic memory drive motors with the major portion of the induced current applied to the load. A generator capability can be added to the motor as shown in FIG. 4 (with labels 3 and 4 referring to input Mux/Demuxer and output Mux/Demuxer capabilities respectively).

When used as a generator, the voltage source switches are opened, the output Mux/Demuxer switch to ground is closed, and contributing coil or coils are closed in the input and output Mux/Demuxers. The switch to a selected load (Z1 to Zn) is closed and induced current is applied to the load. The current applied to the load is measured in real time by the microcontroller. The switching speed of the FETs is so fast the contribution of each of the coils can be measured at essentially the same time. The loads can also be switched in and out instantly. FIG. 4 shows that the magnetic memory motor of the present invention can provide generator capability with minor addons to the motor configuration. It can be switched back and forth from motor to generator and from load to load.

It should be understood that the present invention can be used as a magnetic brake with regenerative braking. This is a variation of a conventional electric generator in which the generated electric energy is used to oppose rotor movement. In this application, the drive coils are sourced and terminated to ground so the forced rotor rotation causes magnetic flux variations through the coils, which in turn causes large, induced current in the low impedance circuit of the coils. This creates large magnetic flux opposing rotor movement and magnetic braking. The induced current caused by magnetic braking can be used in energy recovery applications (such as recharging the battery). The magnetic brake capability can be integrated into the magnetic memory drive functional block diagram as per FIG. 4.

For magnetic memory drive regenerative braking as applicable by the system of the present invention, one of the loads can be of very low, essentially zero impedance. When a load of zero impedance is applied, current and braking are maximum but only minimum battery charging or energy storage of any kind is possible. When a load of super capacitors is applied, energy is stored in the capacitors, and some is used in magnetic braking. When battery charging is applied as a load, some energy goes into magnetic braking, and some is used to charge the battery. When all loads are switched open, very little current is generated in the coils, very little magnetic braking occurs, and coasting occurs. When all load switches are open, the system shown in FIG. 4 can operate as a Magnetic Memory Drive motor. The system illustrated in FIG. 4 can perform computer-controlled brake pumping whereby magnetic braking is switched on and off to prevent sliding on water or ice.

The energy stored in the super capacitors can provide an immediate burst of power to either drive or brake the wheels beyond normal system capabilities for short periods of time. It follows that each wheel is preferably equipped with its own regenerative braking system whereby skid steering is possible and with precision, when making a right turn, the right front and back wheels can be magnetically braked with the energy stored in supercapacitors for immediate application, while the left front and back wheels remain unbraked which causes skid turning for right turns. The braking can be performed in short bursts and with differences from front to rear for precision turning radii which can be varied real time with minimum tire wear and heating. When the immediate need is over, the energy stored in the supercapacitors can be used to charge the battery.

Having illustrated the present invention, it should be understood that various adjustments and versions might be implemented without venturing away from the essence of the present invention. Further, it should be understood that the present invention is not solely limited to the invention as described in the embodiments above, but further comprises any and all embodiments within the scope of this application.

The foregoing descriptions of specific embodiments of the present invention have been presented for purposes of illustration and description. They are not intended to be exhaustive or to limit the present invention to the precise forms disclosed, and obviously many modifications and variations are possible in light of the above teaching. The exemplary embodiment was chosen and described in order to best explain the principles of the present invention and its practical application, to thereby enable others skilled in the art to best utilize the present invention and various embodiments with various modifications as are suited to the particular use contemplated.

I claim:

1. A magnetic memory drive system comprising:
a stator, said stator equipped with magnetic poles;
a rotor;
a microcontroller, said microcontroller equipped with an input measurement terminal;
a power supply, said power supply disposed in communication with said microcontroller; and
wherein said power supply is a DC voltage source system.

2. A method of use of the magnetic memory drive system comprising:
the microcontroller selecting the magnetic poles of the stator to be magnetized;
the power supply connecting to the mux, through the mux to appropriate poles, through pole windings to demux, and through the demux to ground;
magnetizing the poles;
demagnetizing the poles;
disconnecting coils from the power supply and ground and reconnecting the coils to the input measurement terminal of the microcontroller;
the rotor starting to move;
the coil windings acting as a resolver;
the microcontroller monitoring performance; and
demagnetizing a first set of poles while a second set of poles is magnetized.
